(19) United States
(12) Patent Application Publication
(10) Pub. No.: US 2017/0240171 A1
(43) Pub. Date: Aug. 24, 2017

(54) METHOD FOR MODIFYING STEERING OF AN AUTOMATED VEHICLE FOR IMPROVED PASSENGER COMFORT

(71) Applicant: Delphi Technologies, Inc., Troy, MI (US)

(72) Inventors: Michael I. Chia, Cicero, IN (US); Walter K. Kosiak, Kokomo, IN (US); Matthew R. Smith, Springboro, OH (US)

(21) Appl. No.: 15/385,190

(22) Filed: Dec. 20, 2016

Related U.S. Application Data
(60) Provisional application No. 62/296,642, filed on Feb. 18, 2016.

(51) Int. Cl. B60W 30/12; B60W 40/08; B62D 15/02; G05D 1/00

(52) U.S. Cl. CPC B60W 30/12; G05D 1/0088; B60W 40/08; B62D 15/025; B60W 2540/22; B60W 2520/125

(57) ABSTRACT

A vehicle control system for operating an automated vehicle in a fashion more conducive to comfort of an occupant of the automated vehicle includes a sensor, an electronic-horizon database, vehicle-controls, and a controller. The sensor is used to determine a centerline of a travel-lane traveled by a host-vehicle. The electronic-horizon database indicates a shape of the travel-lane beyond where the sensor is able to detect the travel-lane. The vehicle-controls are operable to control motion of the host-vehicle. The controller is configured to determine when the database indicates that following the shape of the travel-lane beyond where the sensor is able to detect the travel-lane will make following the centerline by the host-vehicle uncomfortable to an occupant of the host-vehicle, and operate the vehicle-controls to steer the host-vehicle away from the centerline when following the centerline will make the occupant uncomfortable.

### CROSS-REFERENCE TO RELATED APPLICATION

This application claims the benefit under 35 U.S.C. §119(e) of U.S. Provisional Patent Application No. 62/296,642, filed 18 Feb. 2016, the entire disclosure of which is hereby incorporated herein by reference.

### TECHNICAL FIELD OF INVENTION

This disclosure generally relates to an autonomously driven vehicle and more particularly to a system and method for modifying the steering to create greater passenger comfort.

### BACKGROUND OF INVENTION

It is known in automated driving systems to steer the vehicle with a system that senses the lane side marker lines or edges, though camera vision systems, LIDAR systems, or a fusion of camera and radar. The conventional automated steering algorithm then determines the lane centerline between the side lines and steers the vehicle substantially along that center line. The sensing system cannot see or work ahead of where the vehicle is at any given time, and can only react essentially in real time to what it senses and measures. Therefore, a sharp curve steered through by an automated driving system with only real time lane sensing and with a conventional lane centering algorithm can cause uncomfortable lateral acceleration to the vehicle occupants. In addition, there may be situations where roads are narrow or is narrower than normal (bridges, tunnels), where shoulders are especially narrow, or where, in the face of heavy oncoming traffic, the occupant is uncomfortable psychologically unless the vehicle biases inside or outside relative to the mathematically determined lane centerline.

Digital map data is finding more use in vehicles, autonomously driven and others, as a component in advanced driver assistance systems. These databases are often referred to as electronic-horizons (eH) because of their ability to “see” past the see beyond the horizon or next curve, and to “know” what is coming up in terms of curves, road narrowing, etc. A GPS system knows where the car is, and therefore these road changes can be predicted, in effect. In addition, digital map data can provide useful information that cannot reliably be provided by vision-oriented systems, such as speed limits, traffic and lane restrictions, etc. Further, digital map data can be used to determine the road ahead of the vehicle even around corners or beyond obstructions.

Although the number of lanes may be represented, the map database may not directly represent the coordinates of individual lanes because of the significant increase in the volume of data that would have to be represented. Instead, the links represent a one-dimensional path-line that typically corresponds with the centerline of the roadway. Even in the event that a digital map database does directly represent actual lane boundaries for a given roadway, issues of sporadic positional errors and intermittent availability of the geo-positioning systems have limited the reliability of these systems. Consequently, optical camera-based lane monitoring systems have usually been preferred over GPS-based.

### SUMMARY OF THE INVENTION

In the embodiment disclosed, a vehicle controller is programmed to bias the steering of the vehicle, in situations determined by the electronic-horizon, so as to steer the vehicle in a fashion more conducive to the comfort of the occupant, physically and/or psychologically.

In accordance with one embodiment, a vehicle control system for operating an automated vehicle in a fashion more conducive to comfort of an occupant of the automated vehicle is provided. The system includes a sensor, an electronic-horizon database, vehicle-controls, and a controller. The sensor is used to determine a centerline of a travel-lane traveled by a host-vehicle. The electronic-horizon database indicates a shape of the travel-lane beyond where the sensor is able to detect the travel-lane. The vehicle-controls are operable to control motion of the host-vehicle. The controller is in communication with the sensor, the database, and the vehicle-controls. The controller is configured to determine when the database indicates that following the shape of the travel-lane beyond where the sensor is able to detect the travel-lane will make following the centerline by the host-vehicle uncomfortable to an occupant of the host-vehicle, and operate the vehicle-controls to steer the host-vehicle away from the centerline when following the centerline will make the occupant uncomfortable.

In another embodiment, a vehicle control system is provided where the controller is configured to estimate a lateral-acceleration that the occupant will experience by following the centerline, and determine that the occupant will be uncomfortable if the lateral-acceleration exceeds an acceleration-threshold.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of vehicle control system in accordance with one embodiment;

FIG. 2 is an illustration of a travel-lane traveled by a host-vehicle equipped with the system of FIG. 1 in accordance with one embodiment;

FIG. 3A is an illustration of a travel-lane detected by a sensor of the system of FIG. 1 in accordance with one embodiment;

FIG. 3B is graph corresponding to the travel-lane of FIG. 3A in accordance with one embodiment;

FIG. 4 is an illustration of a travel-lane detected by a sensor of the system of FIG. 1 in accordance with one embodiment;

FIG. 5A is an illustration of a travel-lane detected by a sensor of the system of FIG. 1 in accordance with one embodiment;

FIG. 5B is graph corresponding to the travel-lane of FIG. 5A in accordance with one embodiment; and

FIG. 6 is an illustration of a travel-lane detected by a sensor of the system of FIG. 1 in accordance with one embodiment.

### DETAILED DESCRIPTION

The system described herein employs a method for achieving more natural human performance in lane following systems with an electronic horizon system. An electronic horizon system provides guidance on a travel-lane's shape or profile ahead with latitude and longitude points for the current and upcoming roadway within the electronic horizon's depth (e.g. 1 km ahead) which is far beyond the range of sensors used by the system. This advance information can be relayed to the vehicle-controls (e.g. a steering controller) to allow control that is more similar to a human driver.

Rather than following the centerline of the travel-lane or roadway, the system or method allows the host-vehicle to deviate away from the centerline in circumstances not just limited to the following scenarios: (A) Comfort Curve Control Lateral Bias where the steering maneuver carried out to negotiate curves minimizes lateral-acceleration or lateral-forces by biasing steering to either edge of the travel-lane during curve entries and curve exits, (B) Natural Continuous Curve Lateral Bias where host-vehicle biases steering on continuous curve towards the inside curves edge as a human driver would more typically drive, and (C) Edge Keep Away Lateral Bias where the host-vehicle biases the steering towards center of road on roads where there is no shoulder or less margin for steering drift such as two-lane roadways with no shoulder. Scenarios (A) and (B) can include multiple curve transitions such as S shape curves where desire is to bias towards curve's inner edge, to minimize overall discomfort from lateral forces. Additionally, (D) Electronic Horizon Lane Following Control Modification is an area where useful clues of the travel-lane being traveled can be utilized by a controller to modify steering system response akin to how an operator perceives the road scenario.

Note that an electronic horizon system has data describing the travel-lane ahead that is longer in range than a sensor is able to detect. Therefore, when lane following control system is coupled with an electronic horizon system, systems lags and slower control system responses due to limited sight vision will be significantly reduced.

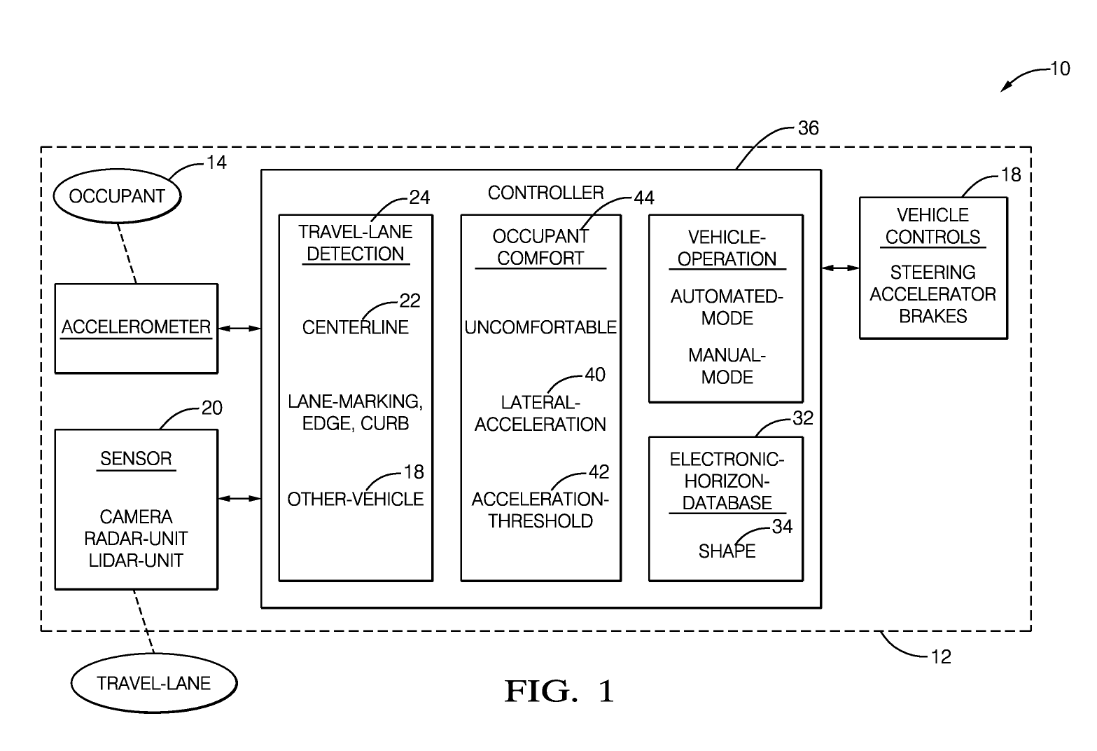

FIG. 1 illustrates a non-limiting example of a vehicle control system 10, hereafter referred to as the system 10. In general, the system 10 is for operating an automated vehicle, e.g. a host-vehicle 12, in a fashion more conducive to the comfort of an occupant 14 of the host-vehicle 12. As used herein, the term ‘automated vehicle’ may apply to instances when the host-vehicle 12 is being operated in an automated-mode, i.e. a fully autonomous mode, where the occupant 14 of the host-vehicle 12 may do little more than designate a destination in order to operate the host-vehicle 12. However, full automation is not a requirement. It is contemplated that the teachings presented herein are useful when the host-vehicle 12 is operated in a manual-mode where the degree or level of automation may be little more than providing an audible or visual warning or aid to the occupant 14 who is generally in control of vehicle-controls 16 that may include, but are not limited to, the steering, accelerator, and brakes of the host-vehicle 12. For example, the system 10 may merely assist the occupant 14 as needed to steer the host-vehicle 12 and/or avoid interference with and/or a collision with, for example, as an other-vehicle 18, a pedestrian, or a road sign.

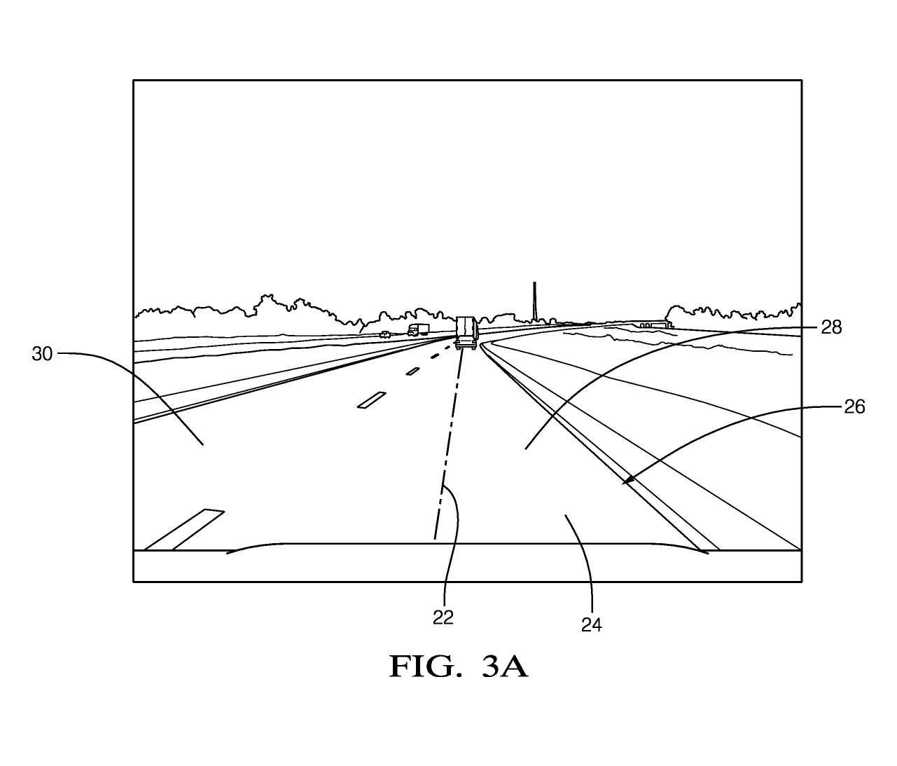

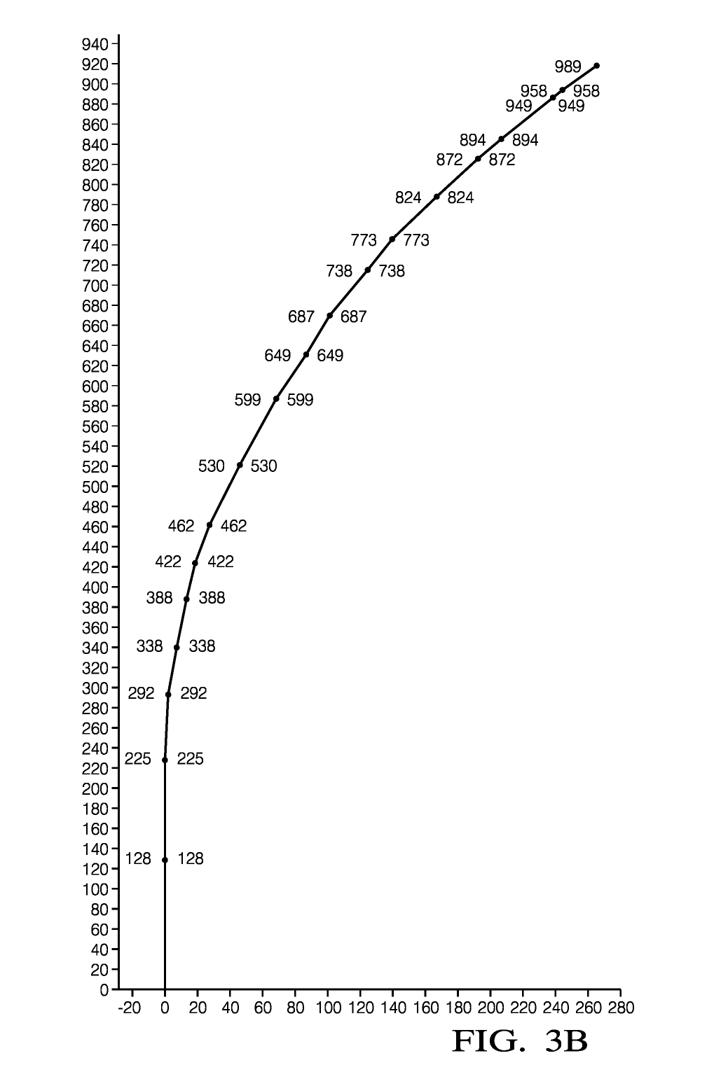

The system 10 includes a sensor 20 used to determine a centerline 22 (see also FIG. 3A) of a travel-lane 24 traveled by the host-vehicle 12. The sensor 20 may be a camera (i.e. video camera), lidar, radar, or any combination thereof. It should be recognized that the camera is the most likely if on one of the possible examples of the sensor 20 is used. It is also contemplated that the image from the camera and data from the lidar or radar could be ‘fused’ to generate a better road model as measuring distance using only the camera can be problematic, as will be recognized by those in the art. Preferably the sensor 20 is mounted at a relatively high location on the host-vehicle 12 to provide a more usable field-of-view, at the top of the windshield for example, possibly behind the windshield.

Typically, the centerline 22 will be in the center of the travel-lane 24 being traveled by the host-vehicle 12. That is, as depicted in FIG. 3A, if the roadway 26 has multiple lanes and the host-vehicle 12 is traveling in the right-lane 28 then the centerline 22 would be along the center of the right-lane 28. If the host-vehicle 12 changed lanes to the left-lane 30, then the centerline 22 would be in the center of the left-lane 30.

The system 10 also includes an electronic-horizon database 32, hereafter referred to as the database 32 which may also be known to some as a digitized-map or a global-positioning-system (GPS) map. The database 32 is useful because it indicates a shape 34 of the travel-lane 24 beyond where the sensor 20 is able to detect the travel-lane 24, i.e. beyond the horizon or behind some visual obstruction such as a hill or vegetation. The data-base 32 may indicate the shape 34 as a series or string of GPS coordinates that can be fit to a polynomial model or piece-wise linear model. By way of example and not limitation, the shape 34 may be as simple as a continuous radius curve, or segments of curves and straight sections, or a high order polynomial that corresponds to the shape 34 of the travel-lane 24 through a series of inflections.

The system 10 also includes the vehicle-controls 16 which are operable to control motion of the host-vehicle 12. The vehicle-controls 16 may be operated by the occupant 14 or by the system 10 without any assistance from the occupant 14. The vehicle-controls 16 may include, but are not limited to, the means to control the steering, accelerator, and/or brakes of the host-vehicle 12. The details of how those means can be provided are known by those in the art.

The system 10 also includes a controller 36 in communication with the sensor 20, the database 32, and the vehicle-controls. The controller 36 may include a processor (not specifically shown) such as a microprocessor or other control circuitry such as analog and/or digital control circuitry including an application specific integrated circuit (ASIC) for processing data as should be evident to those in the art. The controller 36 may include memory (not specifically shown), including non-volatile memory, such as electrically erasable programmable read-only memory (EEPROM) for storing one or more routines, thresholds, and captured data. The one or more routines may be executed by the processor to perform steps for determining a path to steer the host-vehicle 12 based on signals received by the controller 36 as described herein.

The controller 36 may be programmed or configured to determine when the database 32 indicates that following or adhering to the centerline 22 indicated by the shape 34 of the travel-lane 24 beyond where the sensor 20 is able to detect the travel-lane 24 will make following the centerline 22 by the host-vehicle 12 uncomfortable for the occupant 14 of the host-vehicle 12. That the occupant 14 is or may become uncomfortable 38 maybe determined based on an estimate of, for example, a lateral-acceleration 40 that the occupant will experience by following the centerline 22. If the lateral-acceleration 40 exceeds an acceleration-threshold 42, then the controller 36 may operate the vehicle-controls 16 to steer the host-vehicle 12 away from the centerline 22 when following the centerline 22 will make the occupant uncomfortable. The acceleration-threshold 42 may be determined by empirical testing. Other types of acceleration may also be used to estimate the occupant comfort 44 such as, but not limited to, vertical-acceleration, longitudinal-acceleration, and the time-rate of change of any of those acceleration values.

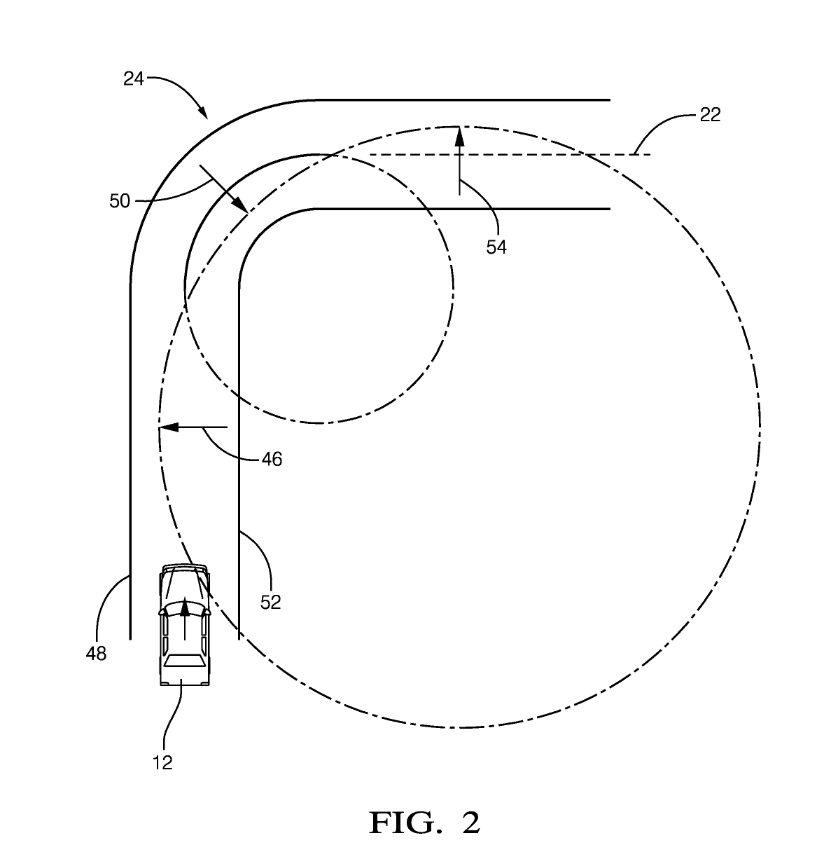

FIG. 2 is directed to (A) COMFORT CURVE CONTROL LATERAL BIAS, which demonstrates more natural driving by a human driver versus a strict algorithmic control which aims for lane center that provides for comfort curve control lateral bias. A human driver operating the host-vehicle 12 may take a wider arc 46 by starting at a point closer to an outside edge 48 of the travel-lane, driving through the apex 50 at which is close to the inner edge 52 and finishing at an exit-point 54 closer to the outside-edge 48 and then later returning smoothly to the centerline 22. A lane following algorithm strictly adhering to maintain lane center by following the centerline 22 would incur more lateral forces making for a more uncomfortable ride than that of the human driver's trajectory.

FIG. 3A and FIG. 3B, as an example of an upcoming right curve, demonstrates information from the curve ahead from an electronic horizon system that is used to anticipate the right curve thus preparing the ego vehicle to commence laterally biasing towards left lane marker prior to maneuvering around the curve. As the curve is completing and about to transition back to a straight road segment, the electronic horizon system will indicate the upcoming end of curve and the lane following control system will prepare to steer the ego vehicle towards the outside curve edge (left edge in this example) to minimize lateral force discomfort. The opposite lateral biasing scheme would be carried out in the example of left curve.

This is an example of (B) NATURAL CONTINUOUS CURVE LATERAL BIAS when driving along a continuous curve, the lane following control system will laterally bias the steering of the ego vehicle towards the curve's inside edge for greater comfortable as is typically carried out by a human driver and provide for natural continuous curve lateral bias.

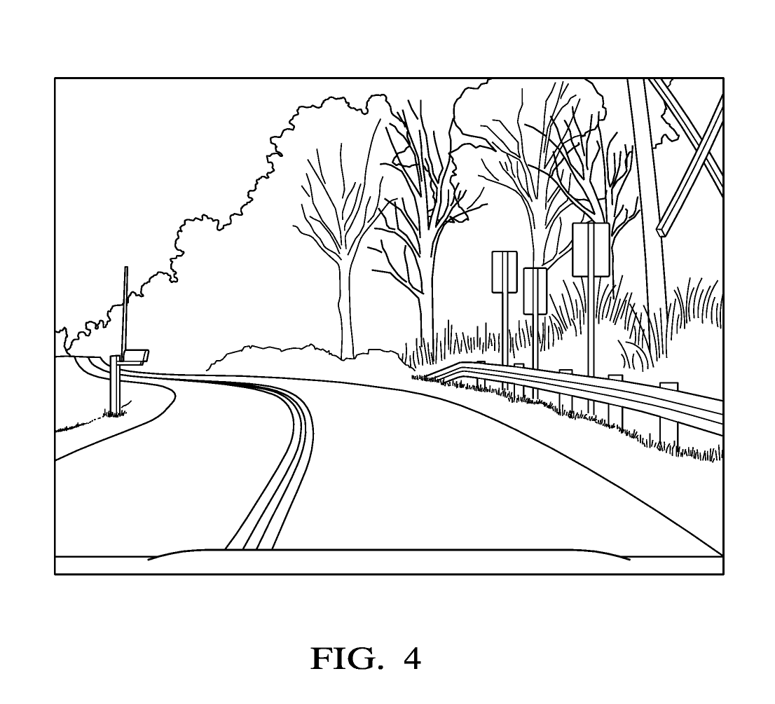

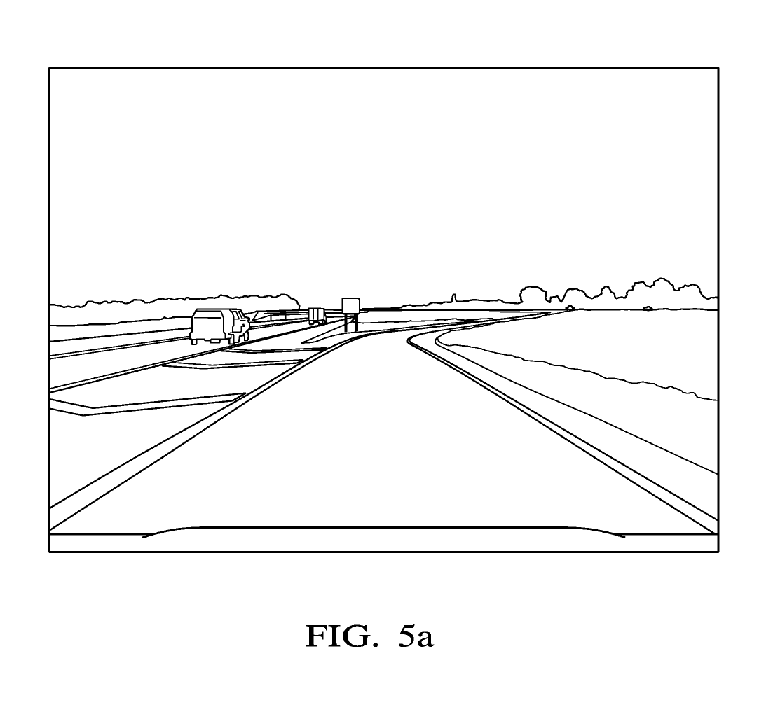

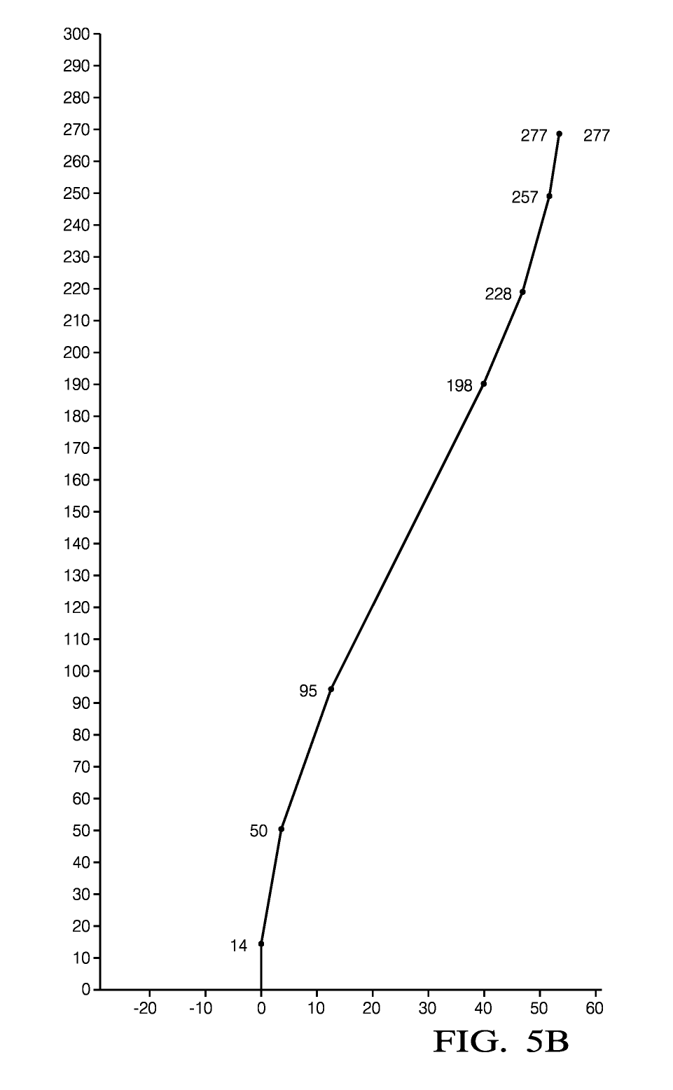

FIG. 4, FIG. 5A, and FIG. 5B illustrate an example of where there can be more complex curve scenarios such as sequential segments of different curve and S shaped curves. This control scheme, with aid from the electronic horizon's information, will aid the lane following controller to maintain a trajectory to negotiate the curves to minimize lateral force. An example is an S shape curve shown in FIG. 4 with companion electronic horizon information.

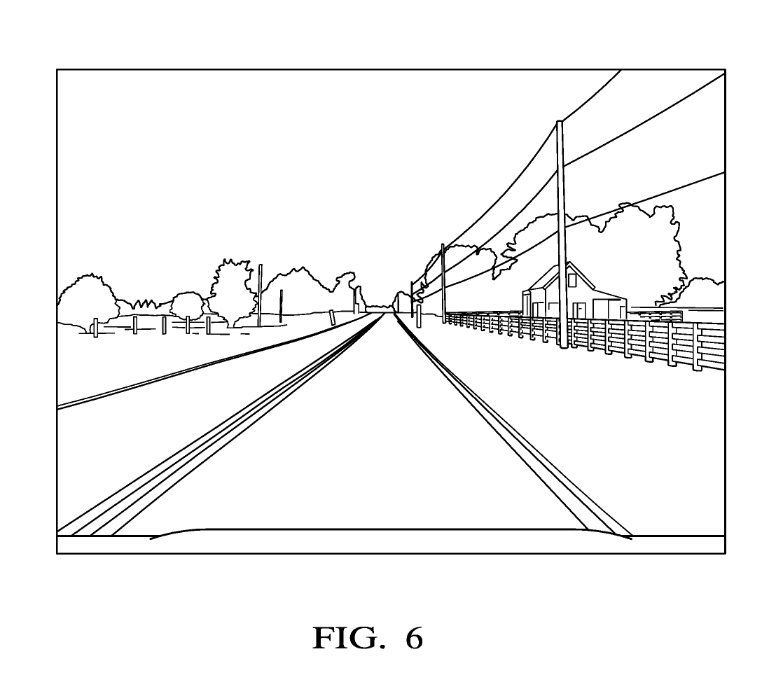

FIG. 6 illustrates an example of a travel-lane with no shoulder where the road edge is grass and is directed to an example of (C) EDGE KEEP AWAY LATERAL BIAS as another example of lane-following provides for edge keep-away lateral bias where the lane centerline is not the most desirable control point is on narrow rural roads, where the lanes are more narrow and have very little or no shoulder roadway beyond the travel-lane. In these cases, the lane centerline is likely to feel too close to the edge of the road when there is no oncoming traffic. By utilizing a combination of the electronic horizon to inform the system about the class of the roadway, form of way, and number of lanes and the vision system to inform about the lane width, these circumstances can be identified. Using the frontal sensor, such as a radar, the system can determine when there is no oncoming traffic and allow the vehicle to drift toward the roadway center. However, when the frontal sensor determines that there is an oncoming vehicle, the host vehicle can be allowed to drift back to the host-lane centerline or even further away from the oncoming lane. In circumstances where the host vehicle speed is of such a speed where the frontal sensor sensing range allows inadequate preview of the oncoming vehicles, this mitigation can be disengaged.

(D) ELECTRONIC HORIZON LANE FOLLOWING CONTROL MODIFICATION is when the system 10 advises of a method to tighten or loosen the lane following controller gains based on data from the electronic horizon (eH) system. Less lane following control deviation from center is allowed (tightening) under circumstances where eH informs the algorithm that the roadway is part of a bridge, tunnel, or curvy mountain road (eH informs about a combination of large gradients and tight curves). More deviation (loosening) of the lane following controller is allowed when eH informs the ego vehicle that the roadway is a highway with straight roads and minimal upcoming curvatures. This eH information is thus used to mimic what a human driver would do on more tense roadway environments where driver is more likely to grip steering wheel more tightly because less lane deviation is required. Similarly a driver would relax more on less tense roadway environments such as straight highways with wider lanes.

While this invention has been described in terms of the preferred embodiments thereof, it is not intended to be so limited, but rather only to the extent set forth in the claims that follow.

We claim:

1. A vehicle control system for operating an automated vehicle in a fashion more conducive to comfort of an occupant of the automated vehicle, said system comprising:
a sensor used to determine a centerline of a travel-lane traveled by a host-vehicle;
an electronic-horizon database that indicates a shape of the travel-lane beyond where the sensor is able to detect the travel-lane;
vehicle-controls operable to control motion of the host-vehicle; and
a controller in communication with the sensor, the database, and the vehicle-controls, said controller configured to
determine when the database indicates that following the shape of the travel-lane beyond where the sensor is able to detect the travel-lane will make following the centerline by the host-vehicle uncomfortable to an occupant of the host-vehicle, and
operate the vehicle-controls to steer the host-vehicle away from the centerline when following the centerline will make the occupant uncomfortable.

2. The system in accordance with claim 1, wherein the controller is configured to estimate a lateral-acceleration that the occupant will experience by following the centerline, and determine that the occupant will be uncomfortable if the lateral-acceleration exceeds an acceleration-threshold.
